(19) United States
(12) Patent Application Publication
(10) Pub. No.: US 2019/0190555 A1
(43) Pub. Date: Jun. 20, 2019

(54) VERY LOW FREQUENCY NOISE CANCELLATION RECEIVER SYSTEM

(71) Applicant: Government of the United States, as epresented by the Secretary of the Air Force, Rome, NY (US)

(72) Inventors: DEAN A PASCHEN, SUPERIOR, CO (US); DANIEL F MCCARTHY, MANLIUS, NY (US); DONALD A HUEBNER, CASTLE ROCK, CO (US); NATHAN M DEBARD, SEATTLE, WA (US)

(21) Appl. No.: 15/844,714

(22) Filed: Dec. 18, 2017

(51) Int. Cl. H04B 1/12; H04L 27/18

(52) U.S. Cl. CPC H04B 1/126; H04L 27/18

(57) ABSTRACT

An apparatus and method for active noise cancellation, including but not limited to, noise cancellation at VLF frequencies. The invention facilitates the reception of critical information in variable and extreme EMI scenario with no information about the signal of interest. The invention utilizes an automated, signal agnostic active noise cancellation technique and associated hardware components. In order to extract the signal of interest, vector modulation is employed to the signal from the noise only antenna so as to match it and then subtract it from the received signal containing combined noise and signal of interest. This apparatus and method ensures that a signal of interest can be extracted from an extremely noisy environment without any knowledge about the characteristics of that signal.

### STATEMENT OF GOVERNMENT INTEREST

The invention described herein may be manufactured and used by or for the Government for governmental purposes without the payment of any royalty thereon.

### TECHNICAL FIELD OF THE INVENTION

This invention relates generally to the field of radio frequency communications, specifically at very low frequencies (VLF). More specifically, this invention relates to radio frequency interference mitigation systems and methods through active noise cancellation.

### BACKGROUND OF THE INVENTION

The rise of modern technologies with both intentional and unintentional VLF radiation (including switching power electronics and their VLF-radiating magnetic cores) has created an electromagnetic interference (EMI) environment for VLF reception that has never been worse—especially in modern airborne environments. In response to these demands, the Air Force, for example, faces an urgent demand to update legacy airborne VLF receive antenna systems to support a more comprehensive set of foreseeable EMI scenarios.

The operation of communication systems in the VLF frequency band is becoming increasingly difficult due to the widespread growth of fixed and mobile systems using electronic devices. Automobile engines, electric motors, and other forms of Electromagnetic Interference (EMI) add to the total noise power from the internal clocks and data signals present in the electronic devices. What is needed is an EMI mitigation system targeted towards VLF, but useful from ELF through HF bands and higher, as a means for dealing with interference from all of these sources of interference and noise.

### OBJECTS AND SUMMARY OF THE INVENTION

It is therefore a primary object of the present invention to provide an apparatus and method to cancel the effects of noise from a received radio frequency signal.

It is another object of the present invention to provide an apparatus and method that cancel the effects of noise from a received radio frequency signal where the radio frequency signal is in the very low frequency (VLF) band.

It is yet another object of the present invention to provide an apparatus and method for cancelling the effects of noise from a very low frequency band received signal that employs automatic computer optimization of the noise cancelling function.

In a preferred embodiment of the present invention, a noise cancellation receiver system comprises a first antenna for receiving and outputting a desired signal and noise, a second antenna for receiving and outputting the noise, a first signal path connected from the first antenna output, comprising a first amplifier having gain adjusted to optimize the downstream cancellation of the noise, a second signal path connected from second antenna output, comprising a second amplifier having gain adjusted to optimize the downstream cancellation of the noise, a quadrature hybrid to generate I and Q components of the noise, and a vector modulator to vary the phase and amplitude of the I and Q components so as to optimize the downstream cancellation of the noise, a summer for summing the vector modulated I and Q components, a summer and amplifier summing outputs of the first and the second signal paths and adjusting the amplitude thereof, a power detector measuring the power at the first antenna output, the second antenna output, and the summed first and second signal paths, a microcontroller in communication with a power detector, the amplifiers, and the vector modulators, wherein the microcontroller computes an algorithm so as to determine and adjust for an amplitude of the vector modulators that minimizes the measured power at the summed first and second signal paths, and a phase value of the vector modulator that minimizes the measured power at the summed first and second signal paths, so as to maximize the cancellation of the noise of the summed first and second signal paths, thereby leaving only that power substantially attributable to the desired signal.

Still, in the preferred embodiment of the present invention, a method for noise cancellation in a receiver system, comprising the steps of receiving a desired signal plus noise on a first channel having gain, receiving noise on a second channel having gain, vector modulating the noise in the second channel 180 degrees out of phase compared to the desired signal plus noise in the first channel, summing the desired signal plus noise output from the first channel and the noise output from the second channel, detecting the power of the summed first and second channels and adjusting the gain and the vector modulation of the second channel so as to minimize the detected power of the summed first and second channels.

Further still, the preferred embodiment of the present invention an algorithm computed by a microcontroller causes a noise cancellation receiver system to read detected power received by a first antenna and by a second antenna, read detected power of summed first and second signal paths from the first and the second antennas, respectively, advance the phase of the second signal path while continuing to read the detected power of the summed first and second signal paths, determine whether the detected power of the summed first and second signal paths has decreased, retard the phase of the second signal path when the detected power of the summed first and second signal paths has not decreased, increase the gain of the second signal path while continuing to read the detected power of the summed first and second signal paths, decrease the gain of the second signal path when the detected power of the summed first and second signal paths has not decreased, and continue to iteratively adjust the phase and the amplitude of the second signal path until the detected power of the summed first and second signal paths reaches a minimum.

Briefly stated, the invention provides an apparatus and method for active noise cancellation, including but not limited to, noise cancellation at VLF frequencies. The invention facilitates the reception of critical information in variable and extreme EMI scenario with no information about the signal of interest. The invention utilizes an automated, signal agnostic active noise cancellation technique and associated hardware components. In order to extract the signal of interest, vector modulation is employed to the signal from the noise only antenna so as to match it and then subtract it from the received signal containing the noise plus the signal of interest. This apparatus and method ensures that a signal of interest can be extracted from an extremely noisy environment without any knowledge about the characteristics of that signal.

### BRIEF DESCRIPTION OF THE DRAWINGS

FIG. 1 is an alternate embodiment of the present invention having vector modulation in the signal plus noise channel as well as in the noise channel.

FIG. 2 is a preferred embodiment of the present invention having vector modulation in only the noise channel.

FIG. 3 is a flowchart of the process performed by the present invention as directed by the microcontroller.

FIG. 4 is a photo of the initial vector modulator design used in the present invention along with test data.

FIG. 5 is a subsequent vector modulator design used in the present invention that includes a quadrature hybrid depicted in the boxed outline.

FIG. 6 is a photograph of the initial active canceller design used in the present invention.

FIG. 7 is a photograph of the subsequent active canceller design used in the present invention.

FIG. 8 is a photograph of the active cancellation test results of the present invention.

### DETAILED DESCRIPTION OF THE PREFERRED EMBODIMENT

The key to the present invention's ability to mitigate “near-field” EMI, which at VLF can be within several kilometers, is the use of two types of antennas, or at least two “channels” into the noise cancellation receiver system. The primary antenna (or channel) responds to both the desired signal and the undesired EMI. A second “noise detection” antenna (or channel), which picks up the EMI, but not the desired signal, allows for cancellation of the interference without degrading the desired signal. A basic cancellation circuit is able to minimize the interference by minimizing total power without the need to protect the desired signal, since the desired signal is essentially not present in the noise channel. In tests to show the power of the present invention, a standard ferrite loopstick antennas was placed in the presence of strong EMI while trying to observe the desired WWV signal. The “noise detection” antenna with the cancellation circuit was able to recover the signal by suppressing the EMI by over 30 dB.

The present invention provides a functional active noise cancellation system for VLF frequencies. The invention can receive critical information in variable and extreme EMI scenario with no information on the signal of interest.

The present invention's architecture relies on two antennas (or channels) receiving spectral information. The “Signal+Noise Antenna” acquires all spectral information within the program's band of interest. This information includes the noise of the surrounding area as well as the signal of interest. The “Noise Antenna” receives all the information that the “Signal+Noise Antenna” does except for the signal of interest. Under normal circumstances, this cancellation could be done primarily through band-pass filtration, but two key requirements make filtration impossible. First, the frequency of the signal of interest is not known at the time of cancellation—instead, the signal of interest can be anywhere within the band. Second, the environment in which this device must operate has EMI levels much higher than the signal of interest. This noise is likely to be extremely wideband, and can be at the same frequency as the signal of interest. Filtration under these circumstances will not accomplish the cancellation necessary to successfully extract the signal.

The “Signal+Noise Antenna” employed for verification testing of the present invention is a “loopstick” antenna design having a total length of 10″. This “loopstick” antenna offers a dramatic reduction of size and weight when compared to legacy products. These prototype “loopstick” antennas are extremely electrically small (less than 1/25,000^{th} of a wavelength). The “loopstick” antennas are created by tightly wrapping insulated wire around a high-permeability ferrite rod (μᵣ=2200). Testing results indicated this antenna provides comparable performance when compared to commercial antennas across the band of interest.

During testing made efforts to improve this antenna for use as the primary receive antenna. The most notable improvement to the performance of the antenna is modification to the balun. The balun is used to transform the antenna signal from balanced to unbalanced so that the signal can be fed into a single-ended operational amplifier (op amp) or a sound card. The balun used in the experiments was sufficient for early demonstrations, but required improvement to support the higher-fidelity investigations. At low frequencies (below 95 kHz), computer sound cards sampling at 192 kHz can be used to characterize signals and display frequency response. The new balun showed improved signal sensitivity at the signal of interest (60 kHz) by 38 dB when fed into a very high impedance operational amplifier. The change only showed a noise level increase of 20 dB for a total SNR increase of 18 dB. This extra sensitivity is critical to maximizing the performance of the invention's interference mitigation properties.

The other feed to the invention's active canceller is the “Noise Antenna” (again, or channel providing noise only). In the present invention, this antenna needs to receive as much EMI as possible while receiving very little of the signal of interest. Initial testing showed that a long bare wire with band-limiting filtering showed comparable performance to more sophisticated EMI sensing techniques. The band-limiting filter configuration used in the present invention is tuned to 35 kHz, allowing the noise antenna to capture EMI in the middle of the band of interest. This EMI is mostly localized to the nearfield and matches the EMI captured by the “loopstick” antenna.

As previously mentioned, the Signal+Noise Antenna (or channel providing signal+noise) collects the EMI in the operating environment and also collects the signal of interest (SOI), and the Noise Antenna provides a reference of just the EMI. In order to extract the SOI, another device is necessary to modulate and match the reference EMI to the EMI attached to the signal. Using vector modulation, the signal from the Noise Antenna can be matched and then subtracted from the signal of interest. This method ensures that a SOI can be extracted from an extremely noisy environment without any knowledge about the characteristics of that signal. The frequency and modulation pattern of the signal does not impact the cancellation process in any way. This means that this canceller is effective in unknown and variable environments. Regardless of the configuration of the antenna, and whether or not spatial cancellation is used, this technique is effective at reducing wideband EMI.

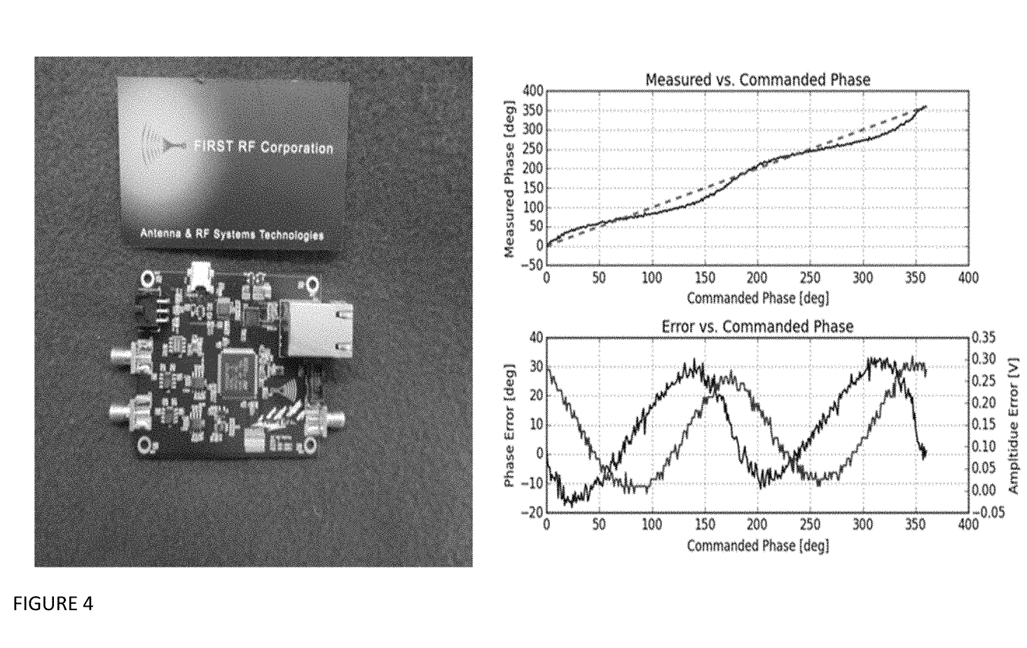

The phase modulation process is an integral part of the present invention. The purpose of this process is to decompose the signal into its I (0°) and Q (90°) components. These I and Q signals can then be modulated as vectors to form any magnitude and phase. The first efforts in the modulation process focused on vector modulating I and Q input signals and determining the accuracy of the measured phase vs the commanded phase. The vector modulation device of the present invention and test data results are shown in FIG. 4. The Measured vs. Commanded phase graph shows general phase steering capabilities; unfortunately, the phase error and amplitude error of the tested configuration vary sinusoidally. This sinusoidal variation of up to 30° makes commanding accurate phases quite difficult. However, this configuration did allow a demonstration of a proof-of-concept vector modulation given input I and Q signals.

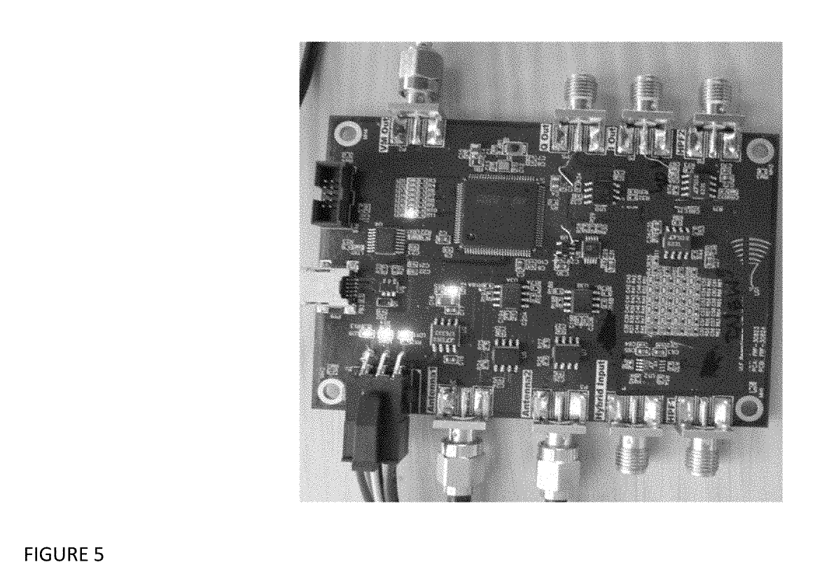

The next design iteration of the present invention included improvements to the vector modulation scheme as well as the first design iteration of the quadrature hybrid device that creates the I and Q signals. This device uses a grid of cascaded resistors and capacitors in order to generate the I and Q vectors from an input signal. The quadrature hybrid is pictured within the box on the circuit board in FIG. 5. The wideband quadrature modulation demonstrated with this device now in the present invention shows significant improvement over modulation achieved in earlier attempts. A comparison between the old modulation scheme and the new scheme achieved by the original device (see FIG. 4) and the new quadrature hybrid (see FIG. 5) was performed. Both modulation schemes achieve a 90° separated quadrature signal, but the present invention's configuration produces an extremely clean (i.e. sinusoidal) quadrature signal separation. The regularity of the modulated signals is crucial to getting high levels of cancellation out of the vector modulated signals. The functional wideband quadrature hybrid and vector modulator form the system-critical prototype elements for an initial full canceller design.

### Initial Active Canceller Design

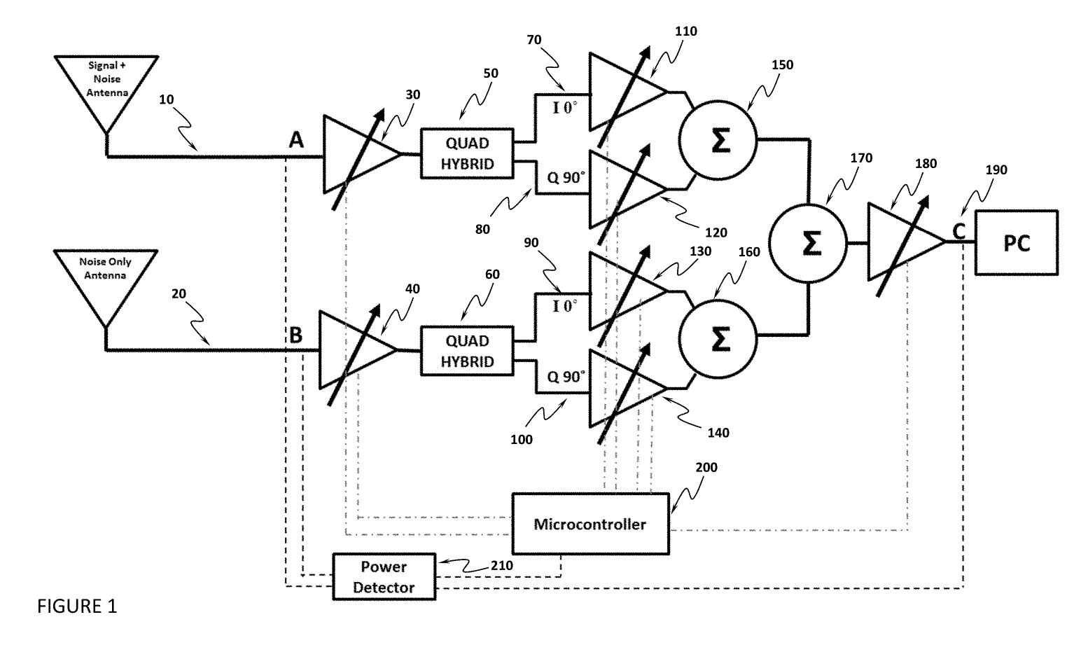

With critical components successfully prototyped, an initial design for a full path active noise cancellation system was developed. This plan is shown in FIG. 1. This device has two identical signal paths (or channels) 10, 20 to guarantee that input signals are magnified and modulated in the same way. The upper path 10 is the path from the Signal+Noise Antenna. This relative power of this signal is sampled with a power detector 210 at point “A”, then boosted by a variable-gain LNA 30 to achieve the largest possible unclipped signal. This signal is then passed through the quadrature hybrid 50 and with I 70 and Q 80 components being then vector modulated 110, 120 to generate a set phase. The two vector modulated signals are then summed 150 into a phase steered signal.

The lower path 20 is the path from the Noise Antenna. This goes through all the same elements as the upper path 10, but instead of being steered to a set phase with the vector modulators, the signal is steered in phase and varied in magnitude to minimize the power seen from the power detector 210 at point “C”. The feedback from this power detector 210 allows the vector modulator to conduct a two-step search to provide optimal noise cancellation. First, the system checks the magnitude of the signal (at 180° phase) that results in the lowest power detector value; next, it performs a sweep over phase values to find a vector that results in the most noise being cancelled when the Noise and Signal+Noise paths are summed together. This summed signal can then be processed by a computer sound card and the signal of interest can be analyzed.

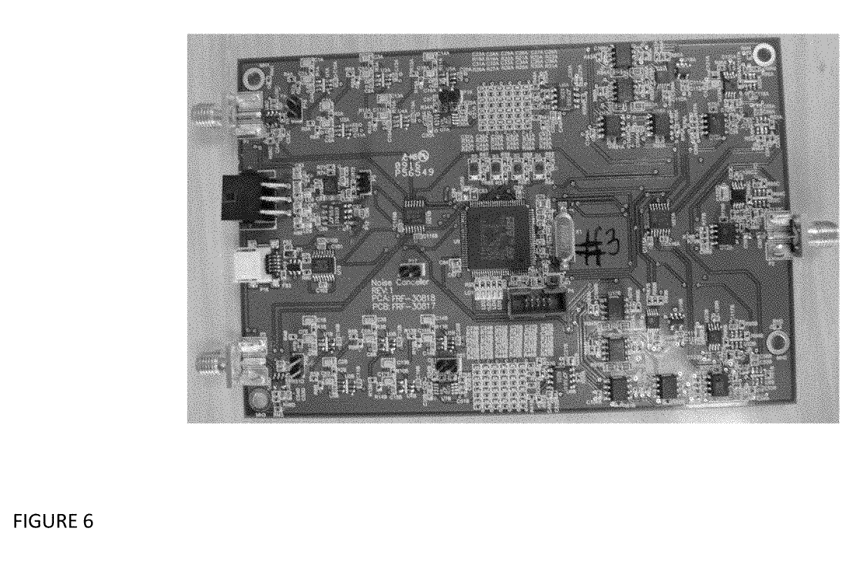

Leveraging Powell's method of finding local minima, the present invention includes an algorithm to quickly modulate the noise path and maximize EMI cancellation. The algorithm may be in the form of software or firmware code implemented by the microcontroller 200. The first iteration manufacture of this active canceller is shown in FIG. 6. This initial canceller design went through initial testing in a laboratory environment. In this test, the EMI is represented as CW tones. The present invention attempts to modulate the signals to maximize the SOI. The “interference” generator created a 55 kHz tone that was injected into the interference (or reference) path of the canceller, while the “signal” generator created a 60 kHz tone. This tone was combined with the 55 kHz interference signal and injected to the canceller's signal path. The resulting output was observed using an oscilloscope and sound card. Using this setup and the cancellation algorithm, automatic realization of greater than 35 dB of cancellation was achieved. The cancellation in this case was limited by the signal of interest's power level. Once the interference approaches the level of the desired signal, the canceller can no longer discern the difference between interferer and signal (unless a priori information about the two signals is available—something the inventors deemed to be unlikely in the operational environment). However, the amount of cancellation achieved still greatly improves the downstream radio's ability to receive and decode the signal of interest.

Though the initial active canceller design was successful in mitigating noise, further improvements were necessary to achieve better EMI cancellation performance.

### Final Active Canceller Design

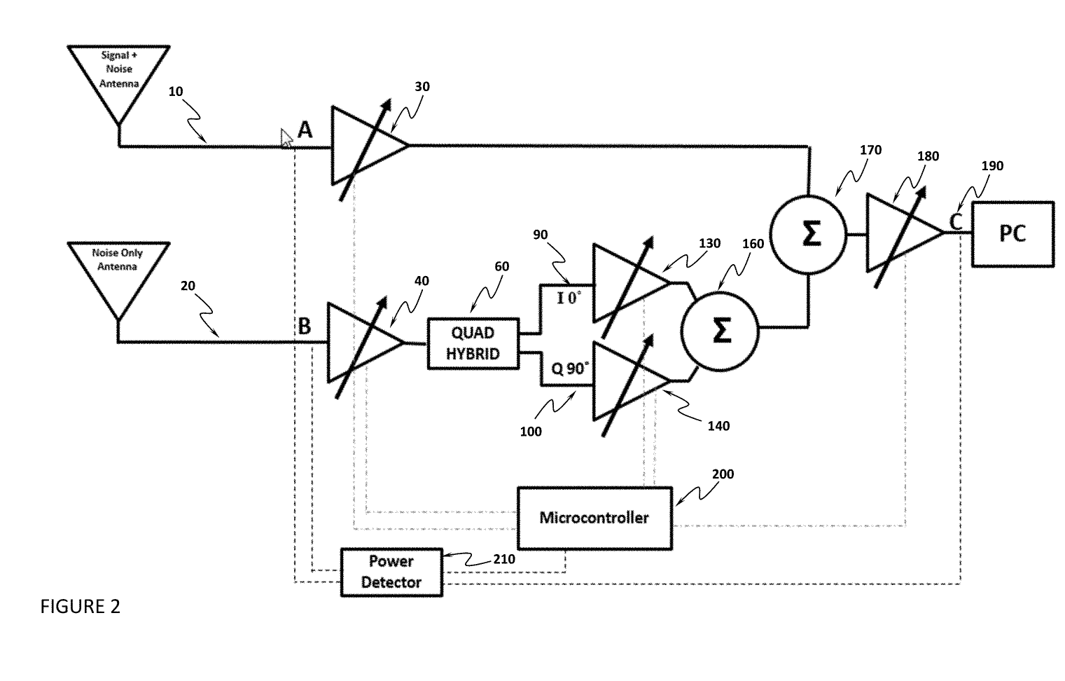

Development of the final active canceller design (see FIG. 2) involved refining component choices and managing signal levels. A component change for the LNA and vector modulator as well as efforts to maximize the use of the linear range of the integrated circuits allow for a cleaner reference to both SOI and the noise in the area. Additionally, these new components simplify the input power requirements. The updated board only needs three references: +7V, −7V, and GND. This is a significant reduction from the previous iteration which required five references: ±15V, ±5V, and GND references.

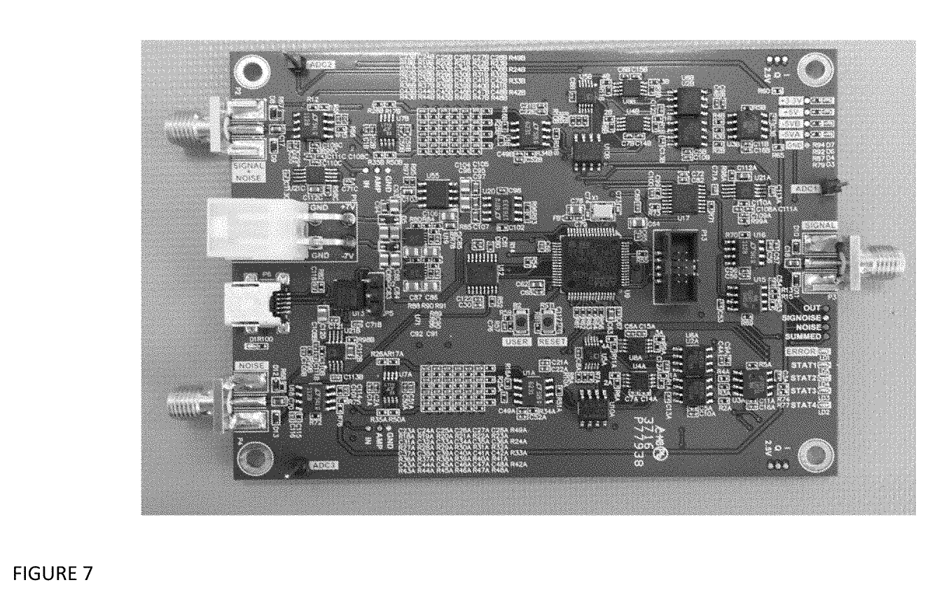

Further understanding the invention's cancellation algorithm allowed for the signal+noise path 10 to avoid vector modulation. In the new configuration, only the noise only path 20 is modulated. This change minimizes modifications to the SOI. This change reduces added noise and significantly reduces the overall complexity of the system. The system diagram for the final design is shown in FIG. 2. When this system diagram is compared to the initial design shown in FIG. 1, the elimination on the signal+noise path 10 of the quadrature hybrid and vector modulators as still used on the on the noise only path 20 significantly reduces the complexity (and improves the noise figure) of the system. The final active canceller board is shown in FIG. 7.

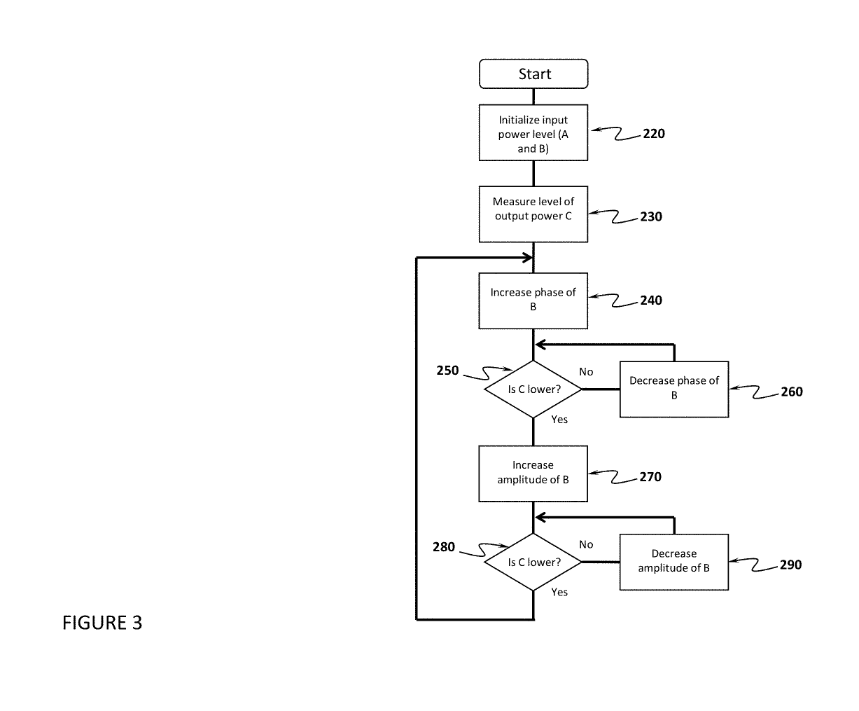

Referring to FIG. 3 concurrently with FIG. 1 or FIG. 2 depicts a process flow implemented by the algorithm, most likely embodied in software or firmware instructions, that is computed by microcontroller 200. The process flow depicted in FIG. 3, refers to reference points A, B and C on FIG. 1 and FIG. 2. Microcontroller 200 reads the initial power 220 received at the first channel (Point A) and the second channel (Point B) as detected by power detector 210. The output power of the summed first and second channels is detected and measured 230 at point C. Next, the phase through the second channel is increased or advanced 240 or (decreased or retarded 260) by means of vector modulation from vector modulation components 60, 90, 100, and 160, while the amplitude of the summed output of the first and second channels is continuously detected and measured at point C. Note that the terms advancing and retarding phase are used synonymously with increasing or decreasing phase. The microcontroller 200 determines 250 whether the power measured at point C is lower as a result of phase advancement through the second channel. If the measured power at C has not decreased as a result of phase advancement of the second channel, then the microcontroller 200 iteratively both decreases the phase 260 through the second channel and continuously measures the power iteratively at point C. Once the microcontroller's algorithm is satisfied that the measured power at pint C is lower as a result of phase adjustment of the second channel, it them increases the gain 40 of the second channel, thereby increasing the amplitude of the noise in the second channel. If increasing the gain in the second channel and thus the amplitude of the noise in the second channel results in a lower detected power 280 at point C, the algorithm will instruct the microcontroller to return to making iterative adjustments to the phase through the second channel and determining the effect of those adjustments on measured power at point C 240, 250, 260. Otherwise, the algorithm will instruct the microcontroller 200 to decrease the gain through the second channel 290 and thus decrease the amplitude of the noise in the second channel until doing so results in a lower detected power at point C.

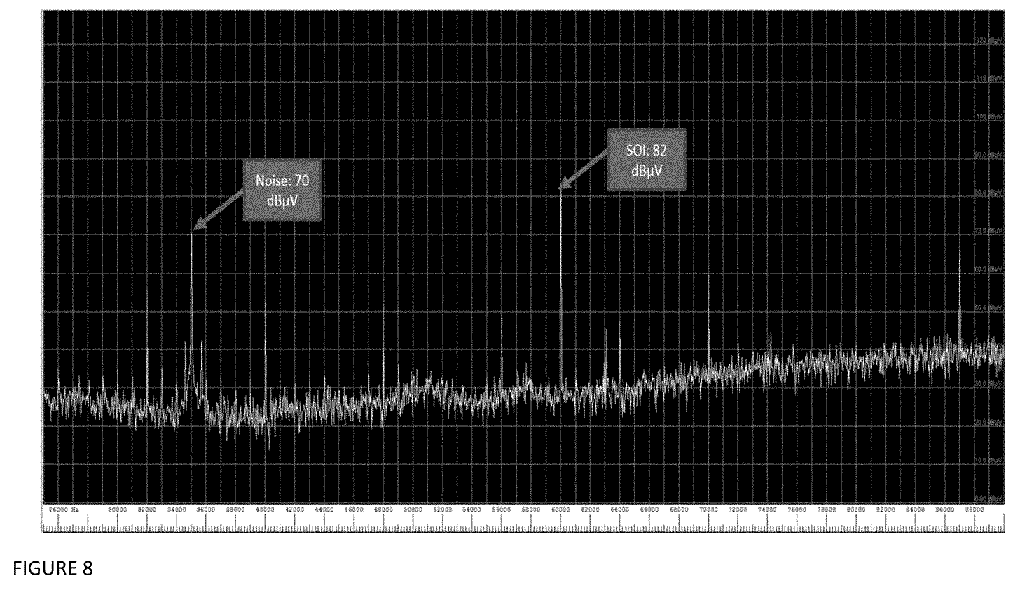

The final active canceller design went through lab testing analogous to that of the initial canceller to gauge the SINR performance of the device compared to its predecessor. For this test, the signal reference used 3 mV peak to peak signal at 60 kHz, and the interference reference is a 300 mV peak to peak signal at 35 kHz. These initial values when converted to a logarithmic scale provide a SINR of −40 dB, indicating the signal is four orders of magnitude (10,000×) smaller than the noise reference with no cancellation. FIG. 8 shows the performance of the device with the same inputs but with the active cancellation process. The SINR in the cancelled state is 12 dB. This indicates that under good conditions, the new cancellation process allows a 52 dB increase in SINR. Due to algorithm, device, and layout improvements, the cancellation performance of the best-case performance of the final cancellation device far surpasses that of the initial canceller. In this test, the noise signal was cancelled from 100 dBuV to 70 dBuV marking a 30 dB cancellation. This is similar performance to the initial canceller, but the most important improvement in the new canceller is that the SOI is taken from a base value of 60 dBuV and boosted to 82 dBuV. The boosting of the signal of interest in conjunction with the cancellation of the interference signal provides excellent EMI cancellation capacity.

For all testing, a WinRadio G331DDC software-defined radio (SDR) is attached to the output of the active noise canceller of the present invention. This SDR captures the frequency spectrum and tracks a “waterfall” view of signal strength across the operational spectrum over time.

The first iteration of testing was to reassert what was found in preliminary testing: that the active cancellation system can reject single interference tones while preserving the signal of interest. For this testing, a signal generator was used as the Noise reference. The Signal+Noise reference is a combination of an antenna received signal (The Fort Collins WWVB signal at 60 kHz) and the signal from the signal generator.

The second iteration of testing was for broadband noise cancellation. This test case was designed to emulate the real-world application of the invention. The signal of interest was again the WWVB signal. The difference in this case was that the noise is the ambient EMI in the area (in this case, provided by a CFL lamp, which produces a profusion of harmonics at around 60 kHz). The Noise signal is captured by a copper wire attached to a 35 kHz tuned preamp. Both inputs of the active noise canceller are attached to variable attenuators to enable testing of different signal characteristics. Both single tone and broadband interference tests were conducted in this manner, with the source for broadband noise being a CFL lamp replacing the single tone from a signal generator.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A noise cancellation receiver system, comprising:
a first antenna for receiving and outputting a desired signal and noise;
a second nearfield-reception antenna for receiving EMI noise from the nearfield and outputting said EMI nearfield noise;
a first signal path connected from said first antenna output, comprising a first amplifier having gain adjusted to optimize the downstream cancellation of said noise;
a second signal path connected from said second nearfield-reception antenna output, comprising
a second amplifier having gain adjusted to optimize the downstream cancellation of said EMI nearfield noise;
a quadrature hybrid to generate I and Q components of said EMI nearfield noise; and
a vector modulator to vary the phase and amplitude of said I and Q components so as to optimize the downstream cancellation of said EMI nearfield noise;
a summer for summing said vector modulated I and Q components;
a summer and amplifier summing outputs of said first and said second signal paths and adjusting the amplitude thereof;
a power detector measuring the power at said first antenna output, said second nearfield-reception antenna output, and said summed first and second signal paths;
a microcontroller in communication with a power detector, said amplifiers, and said vector modulators, wherein said microcontroller computes a software implemented algorithm so as to determine and adjust for:
an amplitude of said vector modulators that minimizes said measured power at said summed first and second signal paths, and
a phase value of said vector modulator that minimizes said measured power at said summed first and second signal paths,
so as to maximize the cancellation of said noise of said summed first and said second signal paths, thereby leaving only that power substantially attributable to said desired signal.

2. A noise cancellation receiver system, comprising:
a first antenna for receiving and outputting a desired signal and noise;
a second nearfield-reception antenna for receiving EMI noise from the nearfield and outputting said EMI nearfield noise;
a first signal path connected from said first antenna output, comprising
a first amplifier having gain adjusted to optimize the downstream cancellation of said noise;
a first quadrature hybrid to generate I and Q components of said signal and noise; and
a first vector modulator to vary the phase and amplitude of said I and Q components so as to establish a reference phase and reference amplitude of said desired signal and noise at the input of said first amplifier; and
a summer for summing said vector modulated I and Q components;
a second signal path connected from said second near-field reception antenna output, comprising
a second amplifier having gain adjusted to optimize the downstream cancellation of said EMI nearfield noise;
a second quadrature hybrid to generate I and Q components of said EMI nearfield noise; and
a second vector modulator to vary the phase and amplitude of said I and Q components so as to match the detected power of said EMI nearfield noise measured at the input of said second amplifier, to said reference amplitude of said desired signal and noise at the input of said first amplifier;
a summer for summing said vector modulated I and Q components;
a summer and amplifier for summing and amplifying outputs of said first and said second signal paths;
a power detector measuring the power at said first antenna output, said second nearfield-reception antenna output, and said summed first and second signal paths;
a microcontroller in communication with a power detector, said amplifiers, and said vector modulators, wherein said microcontroller computes a software implemented algorithm so as to determine and adjust for:
an amplitude of each of said first and said second vector modulators that minimizes said measured power at said summed first and second signal paths, and
a phase value of each of said first and said second vector modulators that minimizes said measured power at said summed first and said second signal paths so as to maximize the cancellation of said noise of said summed first and said second signal paths, thereby leaving only that power substantially attributable to said desired signal.

3. A method for noise cancellation in a receiver system, comprising the steps of:
receiving a desired signal plus noise on a first channel having gain;
receiving EMI nearfield noise on a second channel having gain;
a first step of vector modulating said desired signal plus noise in said first channel;
a second step of vector modulating said EMI nearfield noise in said second channel 180 degrees out of phase compared to said desired signal plus noise in said first channel;
summing said desired signal plus noise output from said first channel and said EMI nearfield noise output from said second channel;
detecting the power of said summed first and second channels; and
adjusting said gain and said vector modulation of said first and said second channels so as to minimize the detected power of said summed first and second channels.

4. A method for noise cancellation in a receiver system, comprising the steps of:
receiving a desired signal plus noise on a first channel having gain;
receiving EMI nearfield noise on a second channel having gain;
vector modulating said EMI nearfield noise in said second channel 180 degrees out of phase compared to said desired signal plus noise in said first channel;
summing said desired signal plus noise output from said first channel and said nearfield noise output from said second channel;
detecting the power of said summed first and second channels; and
adjusting said gain and said vector modulation of said second channel so as to minimize the detected power of said summed first and second channels.

5. The noise cancellation receiver system of claim 1, wherein said software implemented algorithm computed by said microcontroller causes said noise cancellation receiver system to:
read detected power received by said first antenna and by said second nearfield-reception antenna;
read detected power of said summed first and second signal paths;
advance the phase of said second signal path while continuing to read said detected power of said summed first and second signal paths;
determine whether said detected power of said summed first and second signal paths has decreased;
retard the phase of said second signal path when detected power of said summed first and second signal paths has not decreased;
increase the gain of said second signal path while continuing to read said detected power of said summed first and second signal paths;
decrease the gain of said second signal path when detected power of said summed first and second signal paths has not decreased;
continue to iteratively adjust said phase and said amplitude of said second signal path until said detected power of summed first and second signal paths reaches a minimum.
